(19) United States
(12) Patent Application Publication
(10) Pub. No.: US 2013/0276674 A1
(43) Pub. Date: Oct. 24, 2013

(54) METHOD FOR INSERTING CARBON NANOFILLERS INTO AN INORGANIC CURABLE SYSTEM

(71) Applicants: Alexander Korzhenko, Pau (FR); Mickael Havel, Wayne, PA (US); Patrice Gaillard, Hagetaubin (FR); Grigory Ivanovich Yakovlev, Izhevsk (RU); Grigory Nikolayevich Pervushin, Izhevsk (RU); Dimitri Vladimirovich Oreshkin, Moscou (RU)

(72) Inventors: Alexander Korzhenko, Pau (FR); Mickael Havel, Wayne, PA (US); Patrice Gaillard, Hagetaubin (FR); Grigory Ivanovich Yakovlev, Izhevsk (RU); Grigory Nikolayevich Pervushin, Izhevsk (RU); Dimitri Vladimirovich Oreshkin, Moscou (RU)

(73) Assignee: ARKEMA FRANCE, Colombes (FR)

(21) Appl. No.: 13/996,933

(22) PCT Filed: Dec. 20, 2011
(86) PCT No.: PCT/FR2011/053084

§ 371 Date: Jun. 21, 2013

(30) Foreign Application Priority Data
Dec. 21, 2010 (FR) 10.60936

(51) Int. Cl. C04B 14/02

(52) U.S. Cl. CPC C04B 14/026
USPC 106/804; 106/814; 106/802; 106/808; 106/809; 106/810

(57) ABSTRACT

Inorganic curable systems, such as cements, plasters, ceramics, or liquid silicates, which can be used, for example, in the fields of building, construction, or the oil-drilling industry. The use of carbon nanofillers for reinforcing the mechanical properties of such systems and for improving the latter. A method for inserting carbon nanofillers, such as carbon nanotubes, in the form of a binder master batch, into an inorganic curable system with a view to preparing composite materials having improved properties.

### TECHNICAL FIELD

The present invention relates to curable inorganic systems, such as cements, plasters, ceramics or liquid silicates, which can be used, for example, in the fields of building, construction or the oil drilling industry.

The invention relates more particularly to the use of carbon-based nanofillers for reinforcing the mechanical properties and improving such systems. The invention relates to a process for introducing carbon-based nanofillers, such as carbon nanotubes, in the form of a masterbatch based on a binder, into a curable inorganic system for the purpose of preparing composite materials having improved properties.

The invention applies to the fields of construction, building and oil drilling.

### PRIOR ART

Cement-based concrete remains the most commonly employed construction material. Despite the existence of solutions such as the incorporation of metal reinforcements, an ongoing need remains to improve the properties of concretes, whether their mechanical strength, their resistance to aging or the control of the process of hydration of the cement on which the concretes are based.

It has been demonstrated, in preceding studies, that the incorporation of carbon nanotubes in cements exhibits numerous advantageous. This is because carbon nanotubes (or CNTs) confer improved mechanical properties and improved electrical and/or thermal conduction properties on any composite material in which they are present; in particular, their good mechanical properties and in particular their properties of resistance to elongation are related in part to their very high aspect (length/diameter) ratios.

By way of example, in the document US 2008/0134942, the addition of carbon nanotubes at a content of greater than 0.2%, combined with the addition of small contents of a plasticizer, makes it possible to strengthen cements in terms of compressive behavior and strain behavior.

The document WO 2009/099640 describes a method for the preparation of materials based on reinforced cement which consists in dispersing, using ultrasound, carbon nanotubes in a solution of surfactant, in a surfactant/CNTs ratio of between 1.5 and 8, and then mixing the dispersion with a cement, so as to obtain a material comprising from 0.02% to 0.1% of carbon nanotubes, with respect to the cement. The carbon nanotubes employed preferably have a diameter ranging from 20 to 40 nm and a length ranging from 10 to 100 μm. The surfactants are preferably polycarboxylate-based superplasticizers. According to this document, the quality of the dispersion of the CNTs within the material results from the quality of the dispersion of the CNTs in the solution of surfactant obtained by ultrasound. The effects obtained are the increase in Young's modulus and in the bending strength and a reduction in the phenomenon of endogenous shrinkage.

Similar results with regard to the effect of carbon nanotubes as cement reinforcement are described in the document Cement & Concrete Composites, 32 (2010), 110-150.

According to the document Materials Science and Engineering A, 527 (2010), 1063-1067, the mechanical reinforcement resulting in the presence of carbon nanotubes is also accompanied by the densification of the cement.

In the document Fine Chemicals, October 2008, Vol. 25, No. 10, 940-944, a prior oxidation of the carbon nanotubes results in a better retention of the hydrated mass of cement, which is responsible for the CNT/cement adhesion necessary for the mechanical reinforcement of the cements.

Pervushin et al. presented, at the international conference “Nano-technology for green and sustainable construction”, 14-17 Mar. 2010, Cairo, Egypt, the latest results obtained on the reinforcing of cement by virtue of the incorporation of carbon nanotubes at contents as low as 0.006%, with respect to the cement, in the form of an aqueous CNT dispersion obtained by hydrodynamic cavitation in the presence of superplasticizer. However, this study shows that these CNT dispersions are not stable over time and have therefore to be used rapidly for the application of cement reinforcer; the process of dispersion still remain lengthy and difficult to carry out at a higher scale.

Consequently, the introduction of carbon nanotubes into materials based on cement or any other curable inorganic system still brings up a few negative points which have to be improved.

It is therefore desirable to have available a means which makes it possible simply and homogeneously to distribute carbon nanotubes within a material based on cement or any other curable inorganic system for the purpose of preparing composite materials of high mechanical strength and preventing the cracks resulting from the aging of these materials.

In addition, from a toxicological viewpoint, CNTs are generally provided in the form of agglomerated powder grains, the mean dimensions of which are of the order of a few hundred microns. The differences in dimensions, in shape and in physical properties mean that the toxicological properties of CNT powders are not yet fully known. It would thus be preferable to be able to work with CNTs in an agglomerated solid form of macroscopic size.

The Applicant Company has discovered that these needs could be met by introducing the carbon nanotubes into the curable inorganic system not in the powder form but in the form of a masterbatch of carbon nanotubes comprising a polymer binder.

Furthermore, it became apparent to the Applicant Company that this invention can also be applied to other carbon-based nanofillers than carbon nanotubes and in particular to carbon nanofibers and to graphenes, which are also capable of presenting safety problems due to their pulverulent nature and their ability to generate fines in manufacturing plants and which confer good mechanical properties on the materials in which they are present.

An aim of the present invention is thus to provide a process for the introduction of carbon-based nanofillers into curable inorganic systems which is simple, fast and easy to carry out from an industrial viewpoint while respecting health and safety constraints. The process of the invention is easily adapted to existing manufacturing devices in the building and construction industry, and in the oil field.

Another aim of the present invention is to design composite materials based on curable inorganic systems which are denser and mechanically reinforced.

### SUMMARY OF THE INVENTION

A subject matter of the present invention is thus a process for the introduction of carbon-based nanofillers into a curable inorganic system, comprising at least the following stages:
a) the preparation of an aqueous dispersion of carbon-based nanofillers in the presence of at least one superplasticizer;
b) the treatment of the dispersion by high-speed mixing;
c) the addition of said treated dispersion to at least one curable inorganic system in order to ensure a content of carbon-based nanofillers ranging from 0.001 to 0.02% by weight, with respect to the curable inorganic system,
   characterized in that the carbon-based nanofillers are introduced into the dispersion in stage a) in the form of a masterbatch comprising from 20 to 98% by weight, preferably from 25 to 60% by weight, of carbon-based nanofillers and from 2 to 80%, preferably from 40 to 75%, of at least one polymer binder, with respect to the total weight of the masterbatch.

The invention also relates to the composite materials based on curable inorganic systems capable of being obtained according to this process and to their uses in the construction and building field, for preparing mortars for bricklaying or interior and exterior coatings or for manufacturing structural construction products, and in the field of the oil industry, for drilling applications.

Another subject matter of the invention is the use of a masterbatch comprising from 20 to 98% by weight, preferably from 25 to 60% by weight, of carbon-based nanofillers and from 2 to 80%, preferably from 40 to 75%, of at least one polymer binder, with respect to the total weight of the masterbatch, said masterbatch optionally being rediluted in a solvent, in order to mechanically reinforce a curable inorganic system, such as a cement.

The invention also relates to the use of carbon-based nanofillers, such as carbon nanotubes, for improving the resistance to freezing and to the diffusion of liquid of a curable inorganic system, such as a cement, and in particular to the use of a masterbatch comprising from 20 to 98% of carbon-based nanofillers and from 2 to 80% of at least one polymer binder, with respect to the total weight of the masterbatch, said masterbatch optionally being rediluted in the solvent, for improving the resistance to freezing and to the diffusion of liquid of a curable inorganic system, such as a cement.

### DETAILED DESCRIPTION

The process according to the invention relates to curable inorganic systems, that is to say inorganic materials, such as cement bases, which, after mixing with water, cure equally well in air as in water. The agglomerates of these materials which result therefrom, such as concretes, withstand water and exhibit a compressive strength.

Any type of cement base as described in the standard EN-197-1-2000 is especially concerned, in particular Portland-type cement, composite Portland cement, for example with limestone, with slag, with fly ash, with pozzolana, with calcined shale or with silica fume, blast furnace cement, pozzolanic cement, magnesia cement, or other anhydrite-based cement, such as fluoroanhydrite cement, used alone or as a mixture, which constitute concretes, but also materials such as gypsum, which forms the basis for plasters, or ordinary lime.

The invention can also be applied to inorganic materials, such as liquid silicates and ceramics, which cure with heat at high temperature.

Preferably, the curable inorganic system is a cement base.

In the continuation of this description, for reasons of simplicity, the term “carbon-based nanofiller” denotes a filler combining at least one component from the group formed of carbon nanotubes, carbon nanofibers and graphenes, or a mixture of these in all proportions.

According to the invention, the carbon nanotubes participating in the composition of the masterbatch can be of the single-walled, double-walled or multi-walled type. The double-walled nanotubes can in particular be prepared as described by Flahaut et al. in Chem. Comm. (2003), 1442. For their part, the multi-walled nanotubes can be prepared as described in the document WO 03/02456.

The carbon nanotubes employed according to the invention usually have a mean diameter ranging from 0.1 to 200 nm, preferably from 0.1 to 100 nm, more preferably from 0.4 to 50 nm and better still from 1 to 30 nm, indeed even from 10 to 15 nm, and advantageously a length of more than 0.1 μm and advantageously from 0.1 to 20 μm, preferably 0.1 to 10 μm, for example of approximately 6 μm. Their length/diameter ratio is advantageously greater than 10 and generally greater than 100. These nanotubes thus comprise in particular “VGCF” (Vapor Grown Carbon Fibers) nanotubes. Their specific surface is, for example, between 100 and 300 m²/g, advantageously between 200 and 300 m²/g, and their bulk density can in particular be between 0.01 and 0.5 g/cm³ and more preferably between 0.07 and 0.2 g/cm³. The multi-walled carbon nanotubes can, for example, comprise from 5 to 15 sheets and more preferably from 7 to 10 sheets.

These nanotubes may or may not be treated.

An example of crude carbon nanotubes is in particular the trade name Graphistrength® C100 from Arkema.

These nanotubes can be purified and/or treated (for example oxidized) and/or ground and/or functionalized.

The grinding of the nanotubes can in particular be carried out under cold conditions or under hot conditions and can be carried out according to the known techniques employed in devices such as ball mills, hammer mills, edge runner mills, knife mills, gas jet mills or any other grinding system capable of reducing the size of the entangled network of nanotubes. It is preferable for this grinding stage to be carried out according to a gas jet grinding technique and in particular in an air jet mill.

The crude or ground nanotubes can be purified by washing with a sulfuric acid solution so as to free them from possible residual inorganic and metallic impurities, such as, for example, iron, originating from their process of preparation. The ratio by weight of the nanotubes to the sulfuric acid can in particular be between 1:2 and 1:3. The purification operation can furthermore be carried out at a temperature ranging from 90 to 120° C., for example for a period of time of 5 to 10 hours. This operation can advantageously be followed by stages of rinsing with water and of drying the purified nanotubes. In an alternative form, the nanotubes can be purified by heat treatment at a high temperature, typically of greater than 1000° C.

The nanotubes are advantageously oxidized by being brought into contact with a sodium hypochlorite solution including from 0.5 to 15% by weight of NaOCl and preferably from 1 to 10% by weight of NaOCl, for example in a ratio by weight of the nanotubes to the sodium hypochlorite ranging from 1:0.1 to 1:1. Oxidation is advantageously carried out at a temperature of less than 60° C. and preferably at ambient temperature, for a period of time ranging from a few minutes to 24 hours. This oxidation operation can advantageously be followed by stages of filtering and/or centrifuging, washing and drying the oxidized nanotubes.

The nanotubes can be functionalized by grafting reactive units, such as vinyl monomers, to the surface of the nanotubes. The constituent material of the nanotubes is used as radical polymerization initiator after having been subjected to a heat treatment at more than 900° C., in an anhydrous and oxygen-free environment, which is intended to remove the oxygen-comprising groups from its surface. It is thus possible to polymerize methyl methacrylate or hydroxyethyl methacrylate at the surface of carbon nanotubes.

Use is preferably made, in the present invention, of crude carbon nanotubes which are optionally ground, that is to say nanotubes which are neither oxidized nor purified nor functionalized and which have not been subjected to any other chemical and/or heat treatment.

The carbon nanofibers are, like the carbon nanotubes, nanofilaments produced by chemical vapor deposition (or CVD) from a carbon-based source which is decomposed on a catalyst comprising a transition metal (Fe, Ni, Co, Cu), in the presence of hydrogen, at temperatures from 500 to 1200° C. However, these two carbon-based fillers differ in their structure (I. Martin-Gullon et al., Carbon, 44 (2006), 1572-1580). This is because carbon nanotubes consists of one or more graphene sheets wound concentrically around the axis of the fiber to form a cylinder having a diameter of 10 to 100 nm. In contrast, carbon nanofibers are composed of relatively organized graphitic regions (or turbostratic stacks), the planes of which are inclined at variable angles with respect to the axis of the fiber. These stacks can take the form of platelets, fishbones or dishes stacked in order to form structures having a diameter generally ranging from 100 nm to 500 nm, indeed even more.

Preference is furthermore given to the use of carbon nanofibers having a diameter from 100 to 200 nm, for example of approximately 150 nm (VGCF® from Showa Denko), and advantageously a length from 100 to 200 μm.

Graphenes are isolated and separate sheets of graphite but the term graphenes very often refers to assemblages comprising between one and a few tens of sheets. Unlike carbon nanotubes, they exhibit a more or less flat structure with undulations due to thermal agitation which become stronger as the number of sheets is reduced. FLGs (Few Layer Graphene), NGPs (Nanosized Graphene Plates), CNSs (Carbon Nanosheets) and GNRs (Graphene NanoRibbons) are singled out.

Various processes for the preparation of graphenes have been provided, including that of A. K. Geim of Manchester, which consists in tearing off, by successive layers, sheets of graphites using an adhesive tape (scotch-tape method), Geim, A. K., Science (2004), 306, 666.

It is also possible to obtain particles of graphenes by cutting carbon nanotubes along the longitudinal axis (“Micro-Wave Synthesis of Large Few-Layer Graphene Sheets in Aqueous Solution of Ammonia”, Janowska, I. et al., NanoResearch, 2009, or “Narrow Graphene Nanoribbons from Carbon Nanotubes”, Jiao, L. et al., Nature, Vol. 458, pp. 877-880, 2009. Other processes have been widely described in the literature.

Graphenes are produced, for example, by Vorbeck Materials and Angstron Materials.

It is preferable to use carbon nanotubes as carbon-based nanofillers.

According to a first embodiment of the invention, the masterbatch preferably comprises from 25 to 60% by weight of carbon-based nanofillers, indeed even from 40 to 60% of carbon-based nanofillers, and from 40 to 75%, indeed even from 40 to 60%, of at least one polymer binder, with respect to the total weight of the masterbatch.

According to this first embodiment, the masterbatch is provided in the form of granules or of other agglomerated solid forms.

According to a second embodiment of the invention, the masterbatch is diluted beforehand in a solvent before the preparation of the dispersion of stage a), so as to obtain a masterbatch in the form of a pasty composition comprising in particular from 2 to 20% by weight, indeed even from 3 to 10% by weight and better still from 4 to 7% by weight of carbon-based nanofillers, with respect to the total weight of the composition.

This dilution stage can be carried out in a kneader, such as compounding device, or, in an alternative form, in another mixing device, such as a deflocculator.

The solvent is chosen from an organic solvent or water or their mixtures in all proportions. Mention may be made, among organic solvents, of glycols, N-methyl-pyrrolidone (NMP), dimethyl sulfoxide (DMSO), dimethylformamide (DMF), ketones, acetates, furans, alkyl carbonates, alcohols and their mixtures.

The pasty composition thus obtained exhibits a more or less high viscosity ranging from the consistency of a liquid to that of a tar-type paste. The viscosity can thus be between 200 and 1000 mPa·s, for example between approximately 400 and 600 mPa·s, as measured using a Rheomat RM100 model Lamy viscometer provided with a DIN22 measurement system and controlled by VISCO-RM Soft Lamy acquisition software, according to the following protocol: 20 ml of paste are introduced into the measurement cylinder, which is subsequently assembled with the rotor on the apparatus. The viscosity curve is then plotted, the gradient being varied between 1.2 and 1032 s⁻¹ at a temperature of 23° C., and then the viscosity corresponding to a gradient of 100 s⁻¹ is read.

This pasty composition differs in particular from a solid insofar as it is impossible to measure its Young's modulus at ambient temperature and insofar as its softening point is below ambient temperature.

This embodiment can advantageously be employed without treatment by high-speed mixing of the aqueous dispersion thus obtained.

The polymer binder is advantageously chosen from water-soluble polymers, such as polysaccharides or modified polysaccharides. The polymer binder can be chosen from water-soluble products having surface-active properties conferring a superplasticizing role on them. Preferably, the masterbatch includes, as binder, at least one modified polysaccharide, such as a modified cellulose, in particular carboxymethylcellulose (CMC). The masterbatch can be provided in the form of an aqueous solution or in a solid form or also in the form of a liquid dispersion.

An example of a masterbatch is that including 45% by weight of CNTs and 55% by weight of CMC, available in the form of granules, which are sold in particular by Arkema under the trade name Graphistrength® CW2-45.

The masterbatch in the process according to the invention can be prepared according to the following stages:

(i) the dissolution of a polymer binder powder in water, in order to form a solution;

(ii) the mixing of said solution with carbon-based nanofillers in a compounding device;

(iii) the kneading of said mixture.

The preparation of the masterbatch is thus carried out in three successive stages.

One embodiment of stage i) consists in dissolving the powder of the binding polymer in the solvent while stirring the solution thus formed in a time interval of between 30 minutes and 2 hours at a temperature between 0° C. and 100° C., preferably between 20° C. and 60° C.

One embodiment of stage ii) consists in introducing the carbon-based nanofillers and the polymer solution resulting from stage i) into a kneader or compounding device at an introduction temperature of between 10° C. and 90° C.

The carbon-based nanofillers and the polymer solution can be mixed before being introduced into the kneader. In this case, the carbon-based nanofillers and the polymer solution are introduced simultaneously into the same feed region of the kneader, in particular of the Buss® type. In the case where the mixing of the nanofillers with the polymer solution is carried out after introduction into the kneader, the nanofillers and the polymer solution are introduced successively into the same feed region of the kneader or else into two separate feed regions.

One embodiment of stage iii) consists in carrying out the kneading of the mixture by the compounding route, advantageously using a corotating or counterrotating twin-screw extruder or using a co-kneader (in particular of Buss® type) comprising a rotor provided with flights adapted to interact with teeth mounted on a stator. The kneading can be carried out at a temperature preferably of between 20° C. and 90° C.

The masterbatch thus obtained is dried, by any known process (ventilated oven or vacuum oven, infrared, induction, microwaves, and the like), with the aim in particular of removing the water and of thus obtaining a masterbatch containing the desired content of carbon-based nanofillers and advantageously exhibiting a binder/nanofillers ratio by weight of less than 2, indeed even of less than 1.6.

This masterbatch is employed in the form of granules or of other agglomerated solid forms, the conditioning of which facilitates the storage thereof.

According to one embodiment of the invention, the process for the preparation of the masterbatch additionally comprises a stage iv) of dilution in a solvent in order to result in a masterbatch in the form of a pasty composition comprising in particular from 2 to 20% by weight, indeed even from 3 to 10% by weight and better still from 4 to 7% by weight of carbon-based nanofillers, with respect to the total weight of the composition, said pasty composition remaining stable over time and being able to be used as is to prepare the aqueous dispersion of carbon-based nanofillers in stage a) of the process according to the invention.

In the process according to the invention, according to stage a), a dispersion in water of carbon-based nanofillers is prepared starting from a masterbatch of nanofillers as described above and in the presence of at least one superplasticizer.

Mention may be made as examples of superplasticizer, of:
sulfonated salts of polycondensates of naphthalene and formaldehyde, commonly known as polynaphthalene-sulfonates or naphthalene-based superplasticizers;
sulfonated salts of polycondensates of melamine and formaldehyde, commonly known as melamine-based superplasticizers;
lignosulfonates having very low sugar contents;
polyacrylates;
products based on polycarboxylic acids.

It is preferable to use naphthalene-based superplasticizers, such as the condensation products of naphthalenesulfonic acid with formaldehyde, which comprise oligomers of naphthalene methyl sulfonate and sodium naphthalenesulfonate, or superplasticizers of the family of modified sodium lignosulfonates. Use may be made, for example, of the commercial products Megalit C-3, Superplast C-3 or Polyplast SP-1.

The presence of a superplasticizer makes it possible to increase the compactness and the mechanical strength of concretes and mortars, while improving their fluidity and their use. Thus, the content of superplasticizer in the dispersion of nanofillers will be adjusted as a function of the final use of the curable inorganic system; for example, in the case of a fluid cement-based concrete intended for injections, the content of superplasticizer will be greater in order to render the concrete pumpable.

According to the invention, the superplasticizer is dissolved in water at a concentration ranging from 0.003 to 0.5% by weight, preferably from 0.01 to 0.3% by weight.

The masterbatch is then introduced into the aqueous solution of superplasticizer, so as to obtain a content of carbon-based nanofillers ranging from 0.001 to 2% by weight, preferably from 0.005 to 0.02% by weight, for example by using a low-speed mechanical mixer, for a period of time which can range from a few minutes to one hour.

Advantageously, the carbon-based nanofillers/super-plasticizer ratio by weight is between 0.5 and 100, preferably between 1 and 50.

According to one embodiment of the invention, inorganic nanofillers, such as, for example, nanosilica, nanoclay, nanoalumina or other, which can be in the powder form but also in the form of a masterbatch in a matrix, are additionally introduced. The content of inorganic nanofillers in the dispersion can range from 0.01 to 1% by weight. A content of inorganic nanofillers will generally be chosen such that the carbon-based nanofillers/inorganic nanofillers ratio is between 0.5 and 100, preferably between 1 and 10.

The aqueous dispersion of carbon-based nanofillers thus obtained is subjected, according to stage b) of the process according to the invention, to a treatment by high-speed mixing, for example by sonication, by cavitation of the fluids or using a high-shear Silverson mixer, a bead mill, and the like.

Use is preferably made of hydrodynamic cavitation, where the partial vacuum is generated by flow of the fluids. It is possible, for example, to carry out stage b) using the series VTG device, for example the VGT-2.2 device, produced by VGT Servise, Izhevsk, Russia, or any other hydrodynamic cavitation system.

The duration of treatment of stage b) is adjusted as a function of the method used, so as to obtain a dispersion not comprising aggregates above 1 μm visible by optical microscopy. Surprisingly, it has been found that this duration is markedly shorter when the carbon-based nanofillers are introduced into the dispersion in the form of a masterbatch, rather than directly in the powder form, which makes this process easy to operate on the industrial scale. Furthermore, when the dispersion is not of good quality, it turned out that the effect of the nanofillers on the mechanical properties of the final product was less significant. In general, the duration of treatment per liter of dispersion can range from a few minutes to one hour; for example, with an energy of 2.2 kW for the cavitator used, a treatment of 10 minutes was sufficient to achieve the required quality of the dispersion.

According to one embodiment of the process of the invention, it is possible to prepare a concentrated dispersion of carbon-based nanofillers, for example comprising from 0.005 to 2% of carbon-based nanofillers, using the high-speed mixing methods indicated above, and then to dilute this dispersion in water, so as to obtain a content of nanofillers ranging from 0.001 to 0.02%, optionally followed by a finishing treatment in the high- or low-speed mixer.

Stage c) of the process of the invention consists in introducing the dispersion, as is or rediluted, into a curable inorganic system in order to ensure a content of carbon-based nanofillers ranging from 0.001 to 0.02% by weight, preferably from 0.005 to 0.01% by weight, with respect to the curable inorganic system, and a water/curable inorganic system ratio by weight ranging from 0.2 to 1.5, preferably from 0.2 to 0.7, and preferably from 1 to 1.5 in the particular case of concretes intended to be injected. The mixing of the dispersion with the curable inorganic system is carried out directly in any conventional kneading appliance, such as a concrete mixer in the case of cements. This mixing is rapid and generally lasts only a few minutes.

The curable inorganic system, such as a cement, is generally mixed beforehand with a material, such as a sand, in a cement/sand ratio of the order of 1:3. Without the Applicant Company being committed to any one theory, it believes that the presence of the carbon-based nanofillers facilitates the formation of an interfacial layer between the sand and the cement; consequently, the interfaces become more compact and reduce the appearance of cracks and crevices.

According to one embodiment of the invention, the curable inorganic system, such as a cement, is mixed beforehand under dry conditions with hollow glass beads which are optionally treated with an organic compound, for example of silane type, as described, for example, in the documents RU 2267004 or RU 2313559. In this case, the cement/beads ratio by weight ranges from 1:0.2 to 1:1. This embodiment is particularly advantageous for the concretes intended for drilling applications in order to make possible good adhesion with the structures of rocks and wells and an improvement in the resistance to perforation.

The composite materials based on curable inorganic systems obtained following the process according to the invention exhibit improved properties related to the presence of carbon-based nanofillers: increase in the compressive strength, increase in the bending strength, decrease in the endogenous shrinkage, increase in the resistance to cold and to temperature differences, and acceleration in the hydration of the cement.

According to the invention, the use of a masterbatch comprising carbon-based nanofillers in a polymer binder matrix results in a superior performance with regard to mechanical properties of the concretes, in comparison with the direct introduction of the carbon-based nanofillers.

Thus, the process according to the invention is particularly well suited to the preparation of denser and mechanically reinforced concretes, the preparation of cellular concrete or the preparation of plasters.

According to the invention, the use of masterbatch comprising carbon-based nanofillers in a polymer binder matrix, as described in the present description, makes it possible to significantly improve the resistance to freezing and the diffusion of liquid from curable inorganic systems, such as concretes.

The composite materials based on the curable inorganic systems obtained following the process according to the invention are intended for the fields of construction and building, for preparing mortars for bricklaying or interior and exterior coatings or for manufacturing structural construction products, but also for the field of the oil industry, for drilling applications.

The invention will now be illustrated by the following examples, which do not have the purpose of limiting the scope of the invention, defined by the appended claims. In these examples, reference is made to the appended figures, in which:

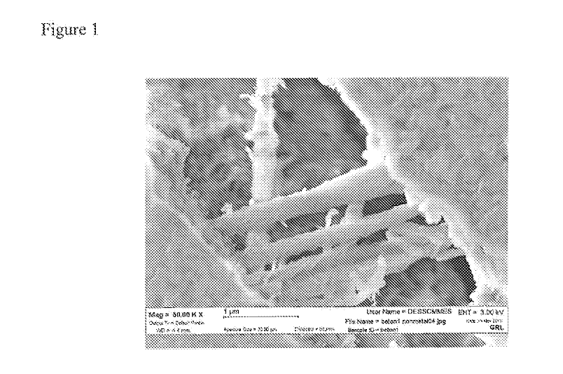

FIG. 1 illustrates, with an SEM, the dispersion of the CNTs within the concrete obtained in example 2;

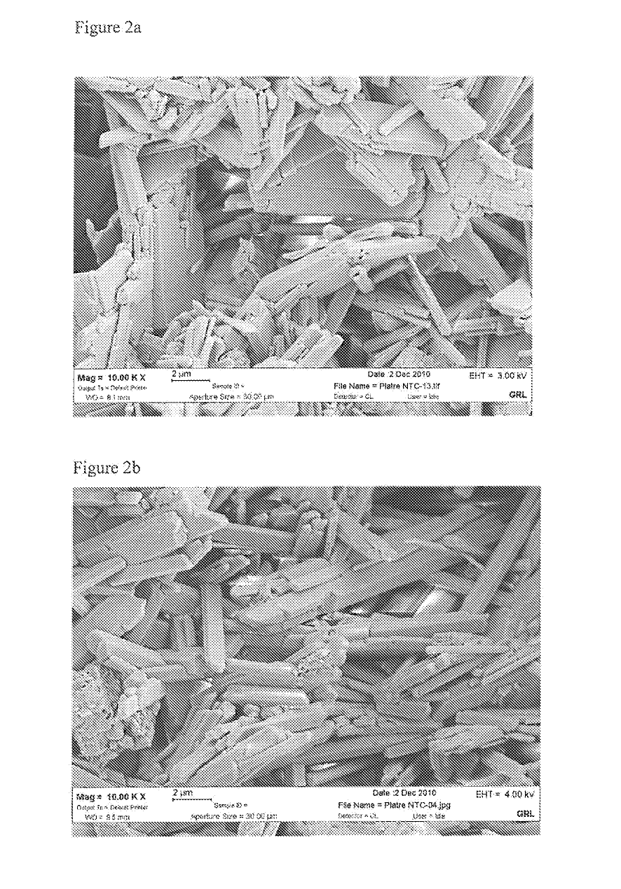

FIGS. 2a and 2b illustrate, with an SEM, the microstructures of plaster prepared according to example 6, in the absence and in the presence of CNTs;

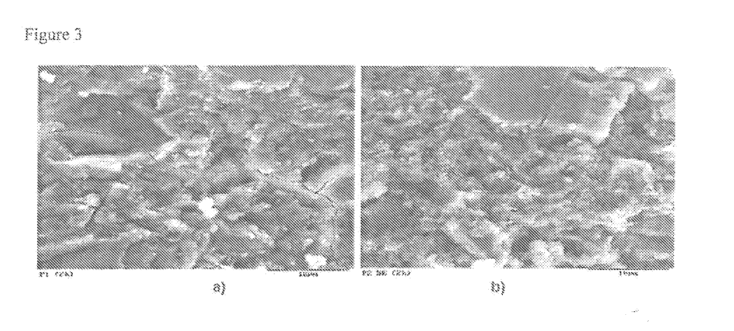

FIGS. 3a and 3b illustrate, with an SEM, the microstructures of a reference concrete and of a concrete prepared according to the invention after a test of resistance to cold.

Unless otherwise indicated, the percentages are expressed by weight.

### Example 1 (Comparative)

### Incorporation of CNTs in Concrete Based on Portland Cement Starting from CNT Powder

A 0.025% by weight solution of superplasticizer Superplast C-3 in water was prepared. The CNTs (Graphistrength® C100 from Arkema) were introduced into this solution using a low-speed mechanical mixer (500 rev/min) for 30 min, so as to obtain a CNT concentration of 0.01% by weight.

The dispersion was treated by hydrodynamic cavitation using the VGT-2.2 device produced by VGT Servise, Izhevsk, Russia. The treatment time for one liter of dispersion is 1 h 40 min with the energy of 2.2 kW. The quality of the dispersion was monitored by optical microscopy in order to confirm the absence of aggregates above 1 μm.

The CNT dispersion was used for the preparation of concrete, starting from CEM I type cement, index 42.5, mixed with quartz sand in a proportion of 1:3 by weight.

Starting from an amount of cement, the amount of CNT dispersion for providing a percentage of CNTs of 0.006%, with respect to the amount of cement, was withdrawn. Water was added to the cement/sand mixture, in order to finally obtain a water/cement ratio of 0.5, by diluting the dispersion beforehand. Mixing is carried out in a cement mixer for 3 minutes.

The concrete thus prepared was placed in preforms having dimensions of 40×40×160 mm densified over a vibrating table for 3 min. The concrete was then stored in the preforms at 20° C. and with a relative humidity of 100% for 24 hours.

Subsequently, the samples were taken out of the preforms and they were conditioned under the same conditions for 27 days.

Mechanical tests in compression and in bending were carried out on these samples on the 28^{th} day of conditioning, according to the following method: GOST 310.4-81 (“Cements. Methods of bending and compression strength determination”).

The results are given in table 1.

### Example 2

### Incorporation of CNTs in Concrete Based on Portland Cement Starting from the Graphistrength® CW2-45 Masterbatch

A 0.01% by weight solution of superplasticizer

Superplast C-3 in water was prepared. CNTs were introduced into this solution by the addition of Graphistrength® CW2-45 from Arkema (CNTs/carboxymethyl-cellulose 45/55), so as to obtain a CNT concentration of 0.01% by weight, by using a low-speed mechanical mixer (500 rev/min).

The dispersion was treated by hydrodynamic cavitation using the VGT-2.2 device produced by VGT Servise, Izhevsk, Russia. The treatment time for one liter of dispersion is 10 min with the energy of 2.2 kW.

The quality of the dispersion was monitored by optical microscopy in order to confirm the absence of aggregates above 1 μm.

The CNT dispersion was used for the preparation of concrete as in example 1 to provide a percentage of CNTs of 0.006%, with respect to the amount of cement, and a water/cement ratio of 0.5.

In the same way as in example 1, concrete samples were prepared in order to carry out mechanical tests in compression and in bending on the 28^{th} day of conditioning.

The results are given in table 1.

FIG. 1, which illustrates, with an SEM, the dispersion of the CNTs within the concrete obtained in this example, demonstrates the effect of healing of the defects in the structure of the concrete. The inorganic layer is formed around the CNTs, promoting the gradual formation of inorganic structures in the shrinkage crevices.

### Example 3

### Incorporation of CNTs and Nanosilica in Concrete Based on Portland Cement, Starting from CNT Powder and Nanosilica in the Powder Form

The same procedure was carried out as in example 1 in order to prepare a dispersion in water comprising 0.01% of superplasticizer Superplast C-3 and 0.01% of Graphistrength® C100 CNTs. Nanosilica was also introduced at a concentration of 0.03% in the form of a powder with a mean size of 350 The treatment time by hydrodynamic cavitation for one liter of CNT and nanosilica dispersion in the VTG-2.2 cavitator is 10 min with the energy of 2.2 kW.

The quality of the dispersion was monitored by optical microscopy in order to confirm the absence of aggregates above 1 μm.

The CNT dispersion was used for the preparation of concrete as in example 1 in order to provide a CNT content of 0.006% and a nanosilica content of 0.03%, with respect to the amount of cement, and a water/cement ratio of 0.5.

In the same way as in example 1, concrete samples were prepared in order to carry out mechanical tests in compression and in bending on the 28^{th} day of conditioning.

The results are given in table 1.

### Example 4 (Comparative)

### Incorporation of CNTs in Concrete Based on Portland Cement, Starting from the Graphistrength® CW2-45 Masterbatch, Without Treatment by Hydrodynamic Cavitation

A 0.01% by weight solution of superplasticizer Superplast C-3 in water was prepared. CNTs were introduced into this solution by the addition of Graphistrength® CW2-45 from Arkema (CNTs/carboxymethyl-cellulose 45/55), so as to obtain a CNT concentration of 0.01% by weight, using a low-speed mechanical mixer (500 rev/min) for 2 hours.

The quality of the dispersion was monitored by optical microscopy; particles between 1 and 10 μm were detected.

The CNT dispersion was used for the preparation of concrete as in example 1 in order to provide a CNT content of 0.006%, with respect to the amount of cement, and a water/cement ratio of 0.5.

In the same way as in example 1, concrete samples were prepared in order to carry out mechanical tests in compression and in bending on the 28^{th} day of conditioning.

The results are given in table 1.

For each series of tests, reference samples were prepared under the same conditions but in the absence of CNTs, nanosilica and superplasticizer.

TABLE 1

| | | % with | | % with |
|---|---|---|---|---|
| | Compressive | respect to | Bending | respect to |
| | strength, | the | strength, | the |
| Sample | MPa | reference | MPa | reference |
| Reference 1 | 17.12 | +39.60 | 1.4 | +42.8 |
| Example 1 | 23.90 | | 2.0 | |
| (comparative) | | | | |
| Reference 2 | 20.37 | +61.17 | 1.0 | +50.00 |
| Example 2 | 32.83 | | 1.5 | |
| Reference 3 | 26.74 | +40.28 | 1.6 | +37.5 |
| Example 3 | 37.51 | | 2.2 | |
| Reference 4 | 18.56 | +5 | 1.1 | +9 |
| Example 4 | 19.44 | | 1.2 | |
| (comparative) | | | | |

An improvement in the mechanical properties of the concrete was observed in the presence of CNTs (example 1), which improvement is greater when the CNTs are introduced in the form of a masterbatch in a carboxymethylcellulose matrix (example 2).

The presence of nanosilica does not greatly change the performance of the CNTs (example 3).

In the absence of treatment by hydrodynamic cavitation of the aqueous CNT dispersion, the improvement is not significant (example 4).

### Example 5

### Incorporation of CNTs in Concrete Based on Fluid Cement which can be Pumped for Use in Drilling Operations as Jacket for Wells

The method described in example 2 was used to prepare an aqueous dispersion comprising 0.01% of CNTs and 0.3% of superplasticizer C-3.

### Example 5a

1 kg of Portland cement, class G (which comprises 95% of pure Portland cement and 3-5% of gypsum), was mixed with 0.5 kg of the aqueous CNT dispersion. In this formulation, the water/cement ratio is 0.5 and the CNT content is 0.005%, with respect to the cement. Mixing was carried out in a paddle mixer at 1000 rpm for 5 min.

Control samples were prepared in the same way with water devoid of CNTs but with the same amount of superplasticizer (0.3%, with respect to the cement).

The concrete thus prepared was placed in preforms with dimensions of 40×40×160 mm densified on a vibrating table for 3 min.

A portion of the samples was conditioned in a heating cabinet at 75° C., under an HDPE plastic wrapping in a water bath; another portion was conditioned in an environmental chamber at 22° C. with a relative humidity of 60%.

The samples thus prepared were tested after conditioning for 24 h.

The results are given in table 2.

### Example 5b

The conditions described in example 5a were reproduced but the Portland cement, class G, (1 kg) was mixed beforehand under dry conditions with 0.3 kg of hollow glass beads (glass microspheres), with the following characteristics:

bulk density: 0.12-0.16 g/cm³,

diameter <60 μm,

thickness of the walls 1-2 μm,

resistance to pressure 15 MPa.

The cement/beads combination was mixed with 1.34 kg of the aqueous CNT dispersion. Mixing with the liquid part was carried out in a paddle mixer at 1000 rpm for 5 min.

In this formulation, the water/cement ratio is 1.34, the CNT content is 0.005%, with respect to cement, and the content of superplasticizer C-3 is 0.03%, with respect to the cement.

The samples, prepared in the same way as in example 5a, were tested after conditioning for 24 h.

### Example 5c

The conditions described in example 5a were reproduced but the Portland cement, class G, (1 kg) was mixed beforehand under dry conditions with 0.5 kg of hollow glass beads (glass microspheres), with the following characteristics:

bulk density: 0.16-0.20 g/cm³,

diameter <60 μm,

thickness of the walls 1-3 μm,

resistance to pressure 18 MPa.

These are glass beads as described in example 5b but treated with 0.3% (with respect to the glass beads) of 7-aminopropyltriethoxysilane (γ-NH₂—(CH₂)₃—Si(0C₂H₅)₃).

The cement/beads combination was mixed with 1.34 kg of the aqueous CNT dispersion. Mixing with the liquid part was carried out in a paddle mixer at 1000 rpm for 5 min.

In this formulation, the water/cement ratio is 1.34, the CNT content is 0.005%, with respect to the cement, and the content of superplasticizer C-3 is 0.015%, with respect to the cement.

The samples, prepared in the same way as in example 5a, were tested after conditioning for 24 h.

TABLE 2

| | | Bending strength, | | Compressive | |
|---|---|---|---|---|---|
| | Cement | MPa, after | | strength, MPa, after | |
| | density | conditioning at | | conditioning at | |
| Sample | g/cm³ | 75° C. | 22° C. | 75° C. | 22° C. |
| 5a | 1.75-1.82 | 7.4 | 3.5 | 24.2 | 11.5 |
| 5a, control | 1.75-1.82 | 5.6 | 2.8 | 17.9 | 9.0 |

### Example 6

### Structure of Plaster Comprising CNTs

A dispersion of CNTs and superplasticizer was prepared as described in examples 2 and 3 starting from the Graphistrength® CW2-45 masterbatch and Superplast C-3. The plaster was prepared from gypsum powder mixed with water, 60% of which is water comprising the CNT dispersion. The mixing time is 3 min. A plaster was obtained comprising 0.005% of CNTs and 0.05% of C-3, with respect to the amount of the gypsum.

The plaster formulation thus prepared was placed in preforms with dimensions of 40×40×160 mm for 40 min. The samples were subsequently taken out of the preforms and conditioned at 20° C. and a relative humidity of 60% for 7 days.

The mechanical tests were carried out after this conditioning in comparison with a reference sample prepared under the same conditions but in the absence of CNTs.

The results are given in table 3.

TABLE 3

| | | % with | | % with |
|---|---|---|---|---|
| | Compressive | respect to | Bending | respect to |
| | strength, | the | strength, | the |
| Sample | MPa | reference | MPa | reference |
| Reference | 4.90 | | 1.42 | |
| Example 6 | 7.15 | +46 | 2.15 | +51 |

A strong enhancement in the mechanical properties was observed, with respect to the CNT-free plaster reference.

FIG. 2a, which illustrates, with an SEM, the microstructure of the plaster obtained in this CNT-free example, shows that the morphology is not compact. The presence of the amorphous regions disrupts the structure.

With 0.005% of CNTs (FIG. 2b), the structure of the plaster is more compact. The CNTs are not observed in these formations of the gypsum.

### Example 7

### Preparation of Fluoroanhydrite-Based Cellular Concrete

Fluoroanhydrite is a waste product from the production of hydrofluoric acid HF from the mineral fluorite. This inorganic product exhibits a mixture of calcium sulfates and fluorides and can be used as cement.

1000 g of fluoroanhydrite were mixed with 500 g of an aqueous solution comprising 10 g (2%) of sodium hydrogensulfate NaHSO₄ and 0.1 g (0.02%) of dispersed CNTs from the Graphistrength® CW2-45 masterbatch according to the method described in example 2. Mixing was carried out with the cavitator as described in example 2.

A solution in water comprising 2% of the foaming agent PB-2000 (produced by Ivhimprom, Ivanovo, Russia) was separately prepared. This solution was placed in a foam generator with an applied pressure of 6 bar. The cement comprising the CNTs was mixed with the foam in the proportion of 1:1 by weight.

The cellular concrete thus prepared was placed in preforms with dimensions of 40×40×160 mm densified on a vibrating table for 3 min, and stored in the preforms for 24 hours at 20° C. under a relative humidity of 100%.

The samples were subsequently taken out of the preforms and conditioned under the same temperature and humidity conditions for 27 days.

The mechanical tests in compression and in bending were carried out on the 28^{th} day of conditioning. The results are given in table 4.

TABLE 4

| | | % with | | % with |
|---|---|---|---|---|
| | Compressive | respect to | Bending | respect to |
| | strength, | the | strength, | the |
| Sample | MPa | reference | MPa | reference |
| Reference | 3.2 | | 1.2 | |
| Example 7 | 3.8 | +19 | 1.4 | +15 |

It was observed that the presence of the CNTs, even at a content as low as 0.005%, improves the mechanical properties of the fluoroanhydrite-based cellular concrete.

### Example 8

### Preparation of Fluoroanhydrite-Based High-Density Concrete

980 g of fluoroanhydrite were mixed under dry conditions with 20 g of CEM I type cement, index 42.5.

This dry mixture was mixed with 350 g of a solution comprising 10 g (or 1% with respect to the cement) of sodium hydrogensulfate NaHSO₄, 6 g (or 0.6%, with respect to the cement) of superplasticizer C-3 and 0.25 g (or 0.0025%, with respect to the cement) of dispersed CNTs from the Graphistrength® CW2-45 masterbatch according to the method described in example 2. Mixing was carried out manually.

The high-density concrete thus prepared was conditioned as described in example 7 before carrying out the mechanical tests on the 28^{th} day of conditioning. The results are given in table 5.

TABLE 5

| | | % with | | % with |
|---|---|---|---|---|
| | Compressive | respect to | Bending | respect to |
| | strength, | the | strength, | the |
| Sample | MPa | reference | MPa | reference |
| Reference | 30.3 | | 5.7 | |
| Example 8 | 40.0 | +24 | 6.7 | +16 |

It was observed that the presence of the CNTs, even at a content as low as 0.0025%, improves the mechanical properties of the fluoroanhydrite-based high-density concrete.

### Example 9

### Incorporation of CNTs in Concrete Based on Portland Cement Starting from a Pasty CNT Composition

A 0.01% by weight solution of superplasticizer Superplast C-3 in water was prepared.

A sample of Graphistrength® CW2-45 from Arkema (CNTs/carboxymethylcellulose 45/55) was introduced with water into a paddle mixer, so that CNT content of the mixture is 7%. After mixing under a speed of 1500 rev/min for 2 hours, a composition comprising 7% of CNTs, existing in the form of a paste, was obtained.

An amount of paste was introduced into the superplasticizer solution, so as to obtain a CNT concentration of 0.01% by weight, using a low-speed mechanical mixer (500 rev/min).

The dispersion was treated by hydrodynamic cavitation using the VGT-2.2 device produced by VGT Servise, Izhevsk, Russia. The treatment time for one liter of dispersion is 10 min with the energy of 2.2 kW. The quality of the dispersion was monitored by optical microscopy in order to confirm the absence of aggregates above 1 μm.

The CNT dispersion was used for the preparation of concrete as in example 1 in order to provide a percentage of CNTs of 0.006%, with respect to the amount of cement and a water/cement ratio of 0.5.

In the same way as in example 1, concrete samples were prepared in order to carry out mechanical tests in compression and in bending on the 28^{th} day of conditioning.

The results of the mechanical tests have demonstrated an improvement of the order of 25% for the compressive strength and of the order of 15% for the bending strength, with respect to the CNT-free reference concrete.

### Example 10

### Incorporation of CNTs in Concrete for Increasing the Resistance to Cold

Two concrete formulations were prepared and shaped into cubes with dimensions of 100×100×100 mm:

### 1) Reference Formulation (Without CNTs)

Portland cement, grade 32.5-460 kg, 5-20 mm-1330 kg, sand 580 kg, superplasticizer Superplast C-3 (0.7%)-3.2 kg, water 170 l

2) Formulation According to the Invention (with CNTs)

The same composition as the above into which 23 g of CNTs were introduced from the Graphistrength® CW2-45 masterbatch.

Tests were carried out according to the GOST 10180-90 standards for the mechanical properties and according to the GOST 10060.2-95 standards for the accelerated evaluation of the strength of the concrete under freeze-thaw conditions.

5 cycles of the accelerated test correspond to 200 real cycles (F200 index).

8 cycles of the accelerated test correspond to 300 real cycles (F300 index).

The results are collated in table 6 below.

TABLE 6

| | | | | Compressive | |
|---|---|---|---|---|---|
| | | | | strength, | Decrease in |
| | | | | initial/ | the |
| | | | | after | compressive |
| Sample | Test | Observation | Index | MPa | strength |
| Reference | 5 cycles | Start of | F200 | | |
| (without | | deterioration | | | |
| CNTs) | | in the | | | |
| | | surface of | | | |
| | | the cubes, | | | |
| | | powdery | | | |
| | | appearance | | | |
| | | at the | | | |
| | | surface | | | |
| | 8 cycles | Significant | F300 | 53.6/48.0 | −10.4 |
| | | deterioration | | | |
| Formulation | 5 cycles | No visible | F200 | | |
| with CNTs | | change | | | |
| | 8 cycles | No | F300 | 52.6/50.3 | −4.4 |
| | | significant | | | |
| | | change | | | |

It was found that the reference concrete is at the limit of the F200 level, whereas the concrete to which CNTs have been added according to the process according to the invention corresponds to a level of resistance to freezing of F300.

The microstructure of the reference concrete after 5 cycles (Index F200) and the microstructure of the concrete according to the invention after 8 cycles (Index F300) are represented respectively in FIGS. 3a) and 3b).

1. A process for the introduction of carbon-based nanofillers into a curable inorganic system, comprising at least the following stages:
a) the preparation of an aqueous dispersion of carbon-based nanofillers, in the presence of at least one superplasticizer;
b) the treatment of the dispersion by high-speed mixing to form a treated dispersion;
c) the addition of said treated dispersion to at least one curable inorganic system in order to ensure a content of carbon-based nanofillers ranging from 0.001 to 0.02% by weight, with respect to the curable inorganic system,
wherein the carbon-based nanofillers are introduced into the dispersion in stage a) in the form of a masterbatch comprising from 20 to 98% by weight of carbon-based nanofillers and from 2 to 80% of at least one polymer binder, with respect to the total weight of the masterbatch.

2. The process as claimed in claim 1, wherein the carbon-based nanofillers are carbon nanotubes.

3. The process as claimed in claim 1, wherein the masterbatch is diluted beforehand in a solvent before the preparation of the dispersion of stage a), so as to obtain a masterbatch in the form of a pasty composition comprising from 2 to 20% by weight of carbon-based nanofillers, with respect to the total weight of the composition.

4. The process as claimed in claim 1, wherein the polymer binder in the masterbatch is a polysaccharide or a modified polysaccharide.

5. The process as claimed in claim 1, wherein the curable inorganic system is a cement base, as described in the standard EN-197-1-2000.

6. The process as claimed in claim 1, wherein use is made, in stage a), of a superplasticizer from naphthalene-based superplasticizers, melamine-based superplasticizers, lignosulfonates having very low sugar contents, polyacrylates or products based on polycarboxylic acids.

7. The process as claimed in claim 1, wherein the aqueous dispersion in stage a) comprises from 0.003 to 0.5% by weight of superplasticizer and from 0.001 to 2% by weight of carbon-based nanofillers.

8. The process as claimed in claim 1, wherein the aqueous dispersion in stage a) additionally comprises inorganic nanofillers in a carbon-based nanofillers/inorganic nanofillers ratio of between 0.5 and 100.

9. The process as claimed in claim 1, wherein the treatment of the dispersion in stage b) is carried out by sonication, by cavitation of the fluids or using a Silverson high shear mixer.

10. The process as claimed in claim 9, wherein the duration of the treatment is adjusted so to obtain a dispersion not comprising aggregates above 1 μm visible by optical microscopy.

11. The process as claimed in claim 1, wherein, in stage c), the content of carbon-based fillers ranges from 0.001 to 0.02%, with respect to the curable inorganic system, and the water/curable inorganic system ratio by weight is from 0.2 to 1.5.

12. The process as claimed in claim 1, wherein the curable inorganic system is a cement.

13. A composite material based on a curable inorganic system capable of being obtained following the process as claimed in claim 1.

14. (canceled)

15. A method of mechanically reinforcing a curable inorganic system, the method comprising applying a masterbatch comprising from 20 to 98% by weight of carbon-based nanofillers and from 2 to 80% of at least one polymer binder, with respect to the total weight of the masterbatch, said masterbatch optionally being rediluted in a solvent, to the curable inorganic system in order to mechanically reinforce the curable inorganic system.

16. A method of improving the resistance to freezing and to the diffusion or liquid in a curable inorganic system, the method comprising applying a masterbatch comprising from 20 to 98% of carbon-based nanofillers and from 2 to 80% of at least one polymer binder, with respect to the total weight of the masterbatch, said masterbatch optionally being rediluted in the solvent, to the curable inorganic system for improving the resistance to freezing and to the diffusion of liquid of the curable inorganic system.
